(19) United States
(12) Patent Application Publication
(10) Pub. No.: US 2017/0174129 A1
(43) Pub. Date: Jun. 22, 2017

(54) VEHICULAR VISUAL INFORMATION SYSTEM AND METHOD

(71) Applicant: SenseDriver Technologies, LLC, Malden, MA (US)

(72) Inventors: Kingsley Chin, Fort Lauderdale, FL (US); Michael Amaru, Reading, MA (US); Aditya Humad, Cambridge, MA (US); Paul Speidel, Beverly, MA (US)

(21) Appl. No.: 15/123,401

(22) PCT Filed: Mar. 6, 2015
(86) PCT No.: PCT/US15/19113

§ 371 Date: Sep. 2, 2016

Related U.S. Application Data
(60) Provisional application No. 61/949,018, filed on Mar. 6, 2014.

(51) Int. Cl. B60R 1/00; B60W 30/09; B60W 40/08; G06K 9/00; G08G 1/0967; G08G 1/16; G06Q 30/02; G01C 21/36; B60W 50/14

(52) U.S. Cl. CPC B60R 1/00; G01C 21/365; B60W 30/09; B60W 40/08; B60W 50/14; G01C 21/3647; G01C 21/3697; G08G 1/0967; G08G 1/166; G06Q 30/0266; G06K 9/00845; G06K 9/00791; B60R 2300/205; B60R 2300/207; B60R 2300/307; B60R 2300/8033; B60R 2300/8093; B60W 2040/0872; B60W 2050/146; B60W 2040/0827

(57) ABSTRACT

Provided is a system and method that captures image information internal and/or external to a vehicle for presentation to a driver, use by the vehicle, and/or for interacting with other internal or external systems. The system can include a vehicle-mounted imager configured to capture images and image information, a vehicle-mounted display, and a visual information processor configured to combine images from the vehicle-mounted imager with extra-image information to generate an output to the display.

### CROSS REFERENCE TO RELATED APPLICATIONS

The present application claims priority under 35 USC 119(e) to U.S. Provisional Patent Application No. 61/949,018, entitled VEHICULAR VISUAL INFORMATION SYSTEM AND METHOD, filed Mar. 6, 2014, the contents of which are incorporated herein by reference in their entirety.

### FIELD OF INTEREST

Inventive concepts relate to the field of vehicular systems, and more particularly to the field of vehicular imaging systems.

### BACKGROUND

Vehicular imaging systems may include those employed in conjunction with automatic parking systems and rear-view, or back-up camera systems, for example. Although beneficial in some limited areas of application, conventional vehicular imaging systems provide only a limited range of vehicular applications.

### SUMMARY

In exemplary embodiments in accordance with principles of inventive concepts, a vehicular visual information system includes at least one vehicle-mounted image capturing device (e.g., camera) configured to capture imagery or images, at least one vehicle-mounted display, and at least one vehicular visual information processor (collectively, “VI processor”). The images include real-world images internal and/or external to the vehicle, and the image information includes at least some of the real-world images internal and/or external to the vehicle. The VI processor is configured to output signals configured to do one or more of: display the images; display the image information; display a combination of the images and/or the image information and/or extra-image information from at least one other source; and/or send control commands to an on-board vehicle system or subsystem.

In accordance with principles of inventive concepts, imaging technology other than visual-range electromagnetic radiation may be employed. That is, for example, RADAR, LIDAR, Infrared Imaging, and sensors responsive to other areas of the electromagnetic spectrum may be employed to produce images that may be displayed to a user. Imagery formed using sensors responsive to radiation outside the visible spectrum may also be combined with visual-range information for a combined image. Therefore, such sensors may be additional or alternative sources of image information.

In exemplary embodiments in accordance with principles of inventive concepts, the VI processor can be configured to provide navigational information based upon images or image information captured by one or more cameras.

In exemplary embodiments in accordance with principles of inventive concepts, the at least one display can include at least one projection display.

In exemplary embodiments in accordance with principles of inventive concepts, the VI processor can be configured to respond to images or image information captured by the camera by controlling one or more movement operations of the vehicle, e.g., steering, braking, accelerating, turning, object avoidance, and so forth.

In exemplary embodiments in accordance with principles of inventive concepts, the VI processor can be configured to control operation of the vehicle or vehicle subsystems by enabling starting of the vehicle.

In exemplary embodiments in accordance with principles of inventive concepts, the VI processor can be configured to control operation of the vehicle or vehicle subsystems in response to recognition of at least one biological characteristic of an actual or potential operator, e.g., based on the image information.

In exemplary embodiments in accordance with principles of inventive concepts, the recognition of a visual biological characteristic can be recognition of a facial characteristic, thumb and/or finger prints, anatomical movement or lack of movement, or patterns of vehicle operator movement, or combinations thereof.

In exemplary embodiments in accordance with principles of inventive concepts, the recognition of a visual biological characteristic can be recognition of an eye or portion thereof of the vehicle operator, e.g., a pupil, or movement thereof.

In exemplary embodiments in accordance with principles of inventive concepts, the VI processor can be configured to control operation of the vehicle by braking, accelerating, and/or maneuvering the vehicle.

In exemplary embodiments in accordance with principles of inventive concepts, the VI processor can be embedded within a display.

In exemplary embodiments in accordance with principles of inventive concepts, the VI processor, or portions thereof, can be embedded within a cellular telephone or tablet and the display is a cellular telephone display or tablet display. For instance, in some embodiments, a cellular telephone (or “cellphone” or “smartphone”) or tablet can include the display, VI processor, and camera, wherein a VI application can be installed on the cellphone or tablet, e.g., stored in it memory and executable by its processor to perform vehicular visual information system functions.

In exemplary embodiments in accordance with principles of inventive concepts, the VI processor can be configured to recognize alert-triggering events captured by the camera and to provide an alert or other action in response to such an event.

In exemplary embodiments in accordance with principles of the inventive concepts, an alert-triggering event can be camera recognition of operator fatigue or distress. As an example, images of certain head movement patterns can be processed to indicate a drowsy or sleeping driver. As another example, images of certain hand movements, possibly in combination with body movements, can be processed to indicate a cardiac event, choking, or some other distress condition.

In various embodiments, the system includes at least one microphone and audio detected from the microphone can be processed by the VI processor, or companion processor, to indicate an alert-triggering event.

In exemplary embodiments in accordance with principles of the inventive concepts, an alert-triggering event can be audio recognition of operator fatigue or distress. As an example, such audio can include snoring sounds from the driver location to indicate driver fatigue. In other examples, audio can be processed to indicate distress, such as keywords or phrases like “Help” or distress sounds such as choking, groaning, and so on.

In exemplary embodiments in accordance with principles of the inventive concepts, the VI processor and/or a companion processor can interpret image information and audio information to determine alter-triggering events.

In exemplary embodiments in accordance with principles of the inventive concepts, the system can include pre-defined patterns of image information, audio information, or both, or combinations thereof as a basis for assessing potential alert-triggering events.

In exemplary embodiments in accordance with principles of the inventive concepts, the system can learn, from driver behavior, patterns of image information, audio information, or both, or combinations thereof as a basis for assessing potential alert-triggering events.

In exemplary embodiments in accordance with principles of inventive concepts, the VI processor can be configured to recognize a flashing light of an emergency vehicle as an alert-triggering event.

In exemplary embodiments in accordance with principles of inventive concepts, the VI processor can be configured to communicate with a map system, to compare a current images from the camera to an image or feature from the map system and to determine whether the current image from the camera matches the image or feature from the map system (e.g., Google Maps, Google Earth, Yahoo Maps, MapQuest, Garmin, TomTom and others).

In exemplary embodiments in accordance with principles of inventive concepts, the VI processor can be configured to periodically obtain images or map information from a map system for a predetermined radius around the current location of the vehicle.

In exemplary embodiments in accordance with principles of inventive concepts, the VI processor can be configured to recognize a reportable event from images and/or image information obtained by the camera and to report the event to another system.

In exemplary embodiments in accordance with principles of inventive concepts, a reportable event can be a road hazard and/or traffic-impacting condition, including, but not limited to, an accident, bad weather, road congestion, construction, and so forth.

In exemplary embodiments in accordance with principles of inventive concepts, the VI processor can be configured to report the road hazard and/or traffic-impacting condition to a crowd-sourced road hazard of traffic condition awareness system (e.g., WAZE).

In exemplary embodiments in accordance with principles of inventive concepts, the projection display can be configured to collimate the image and to project a semi-transparent image onto the front windshield of the vehicle.

In exemplary embodiments in accordance with principles of inventive concepts, the VI processor can be configured to supply advertising information relevant to a vehicle's location.

In exemplary embodiments in accordance with principles of inventive concepts, the VI processor can be configured to wirelessly communicate with one or more of a cellular phone system and/or a satellite system.

In exemplary embodiments in accordance with principles of inventive concepts, the VI processor is configured to communicate over the Internet, or other public or private network of systems and users.

In exemplary embodiments in accordance with principles of inventive concepts, the VI processor is configured to obtain (locally or remotely) stored images of a current location of a vehicle and to augment the image information from the at least one image capturing device.

In exemplary embodiments in accordance with principles of inventive concepts, the VI processor is configured to output for display a combination of the image information and the stored image information, e.g., if visibility is low, e.g., as represented by the captured image information, wherein the stored image information can provide an enhanced or augmented display with improved visibility.

In exemplary embodiments in accordance with principles of inventive concepts, the vehicle can serve as an image collection device that repeatedly collects and stores such image information, locally (at the vehicle), externally (system or network outside the vehicle) or a combination thereof. This can be the case for a plurality of vehicles that collectively contribute image information to a central or distributed database system for shared use across vehicles or mobile devices. The contributions can be made in real-time, near real-time, or post-capture, e.g., periodically, according to a schedule, when in a wi-fi network etc. Shared image information can be used, for example, to alert drivers to hazard or other road conditions, traffic, detours, roadblocks, emergencies, or other circumstances effecting traffic. For example, images from a first driver that were encountered by a vehicle traveling down a street can be shared with another vehicle heading in the same direction or that uses the same route—or can be used to generate an alert to the second vehicle.

Collected image information could also be used by the VI processor (or other processor, e.g., external processor) to determine a vehicle's or driver's normal routes and then advise a driver (e.g., though images, alerts, warnings, or traffic updates) of abnormal conditions or circumstances existing along the route. These can be provided when the processor determines or estimates that the vehicle is traveling along one of the normal routes. In some embodiments, the driver could also be provided with information of a commercial nature relating to businesses along a route, e.g., sales or other promotional events. For example, prior to the vehicle passing a coffee shop on its route, the vehicle could receive an advertisement or coupon (or other promotional item or message) for that coffee shop.

### BRIEF DESCRIPTION OF THE DRAWINGS

The present invention will become more apparent in view of the attached drawings and accompanying detailed description. The embodiments depicted therein are provided by way of example, not by way of limitation, wherein like reference numerals refer to the same or similar elements. The drawings are not necessarily to scale, emphasis instead being placed upon illustrating aspects of the invention. In the drawings:

FIG. 1 is a schematic diagram that illustrates an embodiment of external locations where one or more cameras may be mounted to a vehicle, in accordance with principles of inventive concepts;

FIG. 2 is a schematic diagram that illustrates an embodiment of internal locations where a camera may be mounted within a vehicle, in accordance with principles of inventive concepts;

FIG. 3 is a block diagram of an embodiment of a vehicular visual information system, in accordance with principles of inventive concepts;

FIG. 4 is an exemplary embodiment of a vehicular projection display, in accordance with principles of inventive concepts;

FIG. 5 is flowchart representing an exemplary embodiment of a vehicle images processing method, in accordance with principles of inventive concepts; and

FIG. 6 is a block diagram of an embodiment of a VI processor, in accordance with principles of inventive concepts.

### DETAILED DESCRIPTION

Various exemplary embodiments will be described more fully hereinafter with reference to the accompanying drawings, in which some exemplary embodiments are shown. The present inventive concept may, however, be embodied in many different forms and should not be construed as limited to the exemplary embodiments set forth herein.

It will be understood that, although the terms first, second, etc. are be used herein to describe various elements, these elements should not be limited by these terms. These terms are used to distinguish one element from another, but not to imply a required sequence of elements. For example, a first element can be termed a second element, and, similarly, a second element can be termed a first element, without departing from the scope of the present invention. As used herein, the term “and/or” includes any and all combinations of one or more of the associated listed items.

It will be understood that when an element is referred to as being “on” or “connected” or “coupled” to another element, it can be directly on or connected or coupled to the other element or intervening elements can be present. In contrast, when an element is referred to as being “directly on” or “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, steps, operations, elements, and/or components, but do not preclude the presence or addition of one or more other features, steps, operations, elements, components, and/or groups thereof.

Spatially relative terms, such as “beneath,” “below,” “lower,” “above,” “upper” and the like may be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as “below” and/or “beneath” other elements or features would then be oriented “above” the other elements or features. The device may be otherwise oriented (e.g., rotated 90 degrees or at other orientations) and the spatially relative descriptors used herein interpreted accordingly.

Exemplary embodiments are described herein with reference to cross-sectional illustrations that are schematic illustrations of idealized exemplary embodiments (and intermediate structures). As such, variations from the shapes of the illustrations as a result, for example, of manufacturing techniques and/or tolerances, are to be expected. Thus, exemplary embodiments should not be construed as limited to the particular shapes of regions illustrated herein but are to include deviations in shapes that result, for example, from manufacturing. Thus, the regions illustrated in the figures are schematic in nature and their shapes are not intended to illustrate the actual shape of a region of a device and are not intended to limit the scope of inventive concepts.

To the extent that functional features, operations, and/or steps are described herein, or otherwise understood to be included within various embodiments of the inventive concept, such functional features, operations, and/or steps can be embodied in functional blocks, units, modules, operations and/or methods. And to the extent that such functional blocks, units, modules, operations and/or methods include computer program code, such computer program code can be stored in a computer readable medium, e.g., such as non-transitory memory and media, and be executable by at least one computer processor.

In exemplary embodiments in accordance with principles of inventive concepts, a vehicular visual information system is provided that includes at least one imager (e.g., camera), at least one display, and at least one processor. The system captures vehicle-related images and image information and responds either directly to the images or image information (for example, by displaying or storing the images) or indirectly, to information contained within the images (for example, by recognizing static or dynamic patterns or features, such as facial features). The system may display, process, or otherwise analyze images captured by the imager(s) or information contained therein. The system may be configured to display to a user vehicle-related images obtained from the imager(s) (images, for example, obtained from the direction in which the vehicle is traveling), in combination with extra-image information, such as navigational information (for example, arrows indicating the direction of intended travel). In exemplary embodiments in accordance with principles of inventive concepts, a system may include one or more imagers (e.g., cameras) that is positioned within a vehicle passenger compartment in a manner that allows viewing of any location within the passenger compartment. Similarly, one or more displays may be positioned within a vehicle passenger compartment to permit viewing from any location (passenger side, or rear seat, for example) within the vehicle.

In exemplary embodiments in accordance with principles of inventive concepts, a vehicular visual information system may be configured to capture images from within a vehicle and may employ such images or image information to enable or disable or otherwise control operation of the vehicle, through facial, pupil, thumb or finger print, or other biologic identification process.

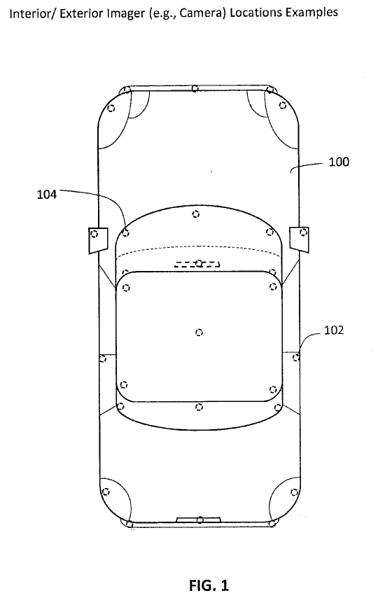

The schematic diagram of FIG. 1 depicts a vehicle 100 that employs a vehicular visual information system in accordance with principles of inventive concepts. One or more cameras may be mounted on the exterior of the vehicle 100, as indicated by circles 102, or in the interior of the car, as indicated by circles 104, or internally and externally. As will be described in greater detail in the description related to the following figures, at least one imager (e.g., camera) is included in the system and it may be mounted internally or externally. The at least one imager (e.g., camera) may be directed to the interior (e.g., toward a driver), or “cab,” of the vehicle 100 or may be directed to the exterior of the vehicle, e.g., directed forward (in the direction of vehicular travel), sideways, rearward, or combinations thereof. A plurality of imagers (e.g., cameras) may be employed, mounted internally or externally, and may they may be directed both toward the cab of the vehicle and toward the direction of vehicle travel, for example. A plurality of cameras, as an example, may be pointed in the same direction, to allow for stereoscopic image capture and analysis, for example. In some embodiments, stereo cameras can be used.

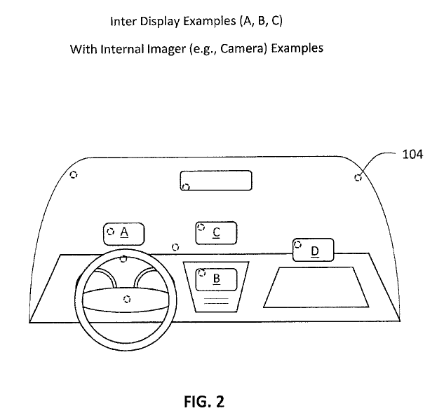

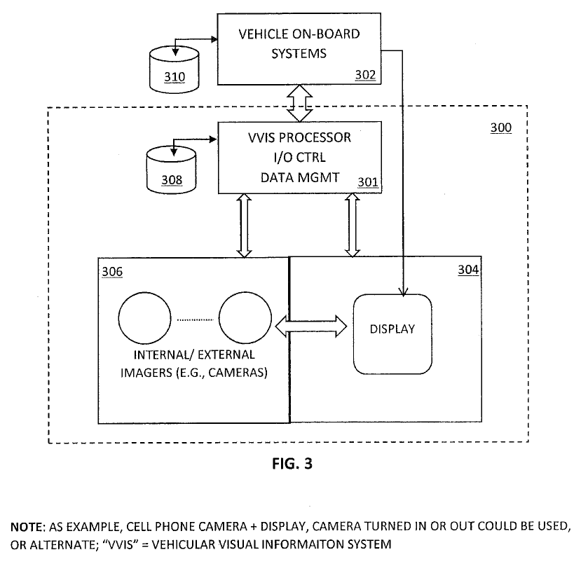

The schematic diagram of FIG. 2 depicts a view within the cab of a vehicle that may employ a system in accordance with principles of inventive concepts, as viewed looking toward the front windshield of the vehicle. Interior imagers (e.g., cameras) 104 may be mounted in a variety of locations, such as those indicated by the small circles 104. Such imagers (e.g., cameras) may be mounted to capture images within the cab of the vehicle or to capture images outside the vehicle (in the direction of vehicle travel, for example). As will be described in greater detail in the discussion related to upcoming figures, one or more interior-mounted imagers may be a camera incorporated in a cellular telephone, tablet computer, or phablet, as examples. One or more displays, which may be located, for example, as indicated by displays A, B, C, and D in a variety of locations within the vehicle cab may be implemented as displays incorporate within a cellular telephone, a tablet computer, or a phablet, as examples. In this exemplary embodiment, displays A and C may be dash-mounted displays, for example, which may obstruct a small portion of a user's view of the road. Alternatively, displays A or C or D may be semitransparent displays, such as a projected displays, that are reflected or otherwise projected on to a vehicle windshield or other device for semitransparent viewing. A semitransparent projected display would allow an operator to view information provided, for example, from imagers 102, 104 along with extra-image information, without substantially interfering with the operator's view of the road ahead. In exemplary embodiments in accordance with principles of inventive concepts, images rendered by the projected display can be collimated and, as a result, the images appear to be projected out in front of the display, e.g., at optical infinity, and an operator's eyes do not need to refocus between viewing the display and the outside world. In some embodiments, the images can be projected at or near the front of the vehicle.

FIG. 3 is a block diagram of an exemplary embodiment of a vehicular visual information system 300 in accordance with principles of inventive concepts. In this exemplary embodiment, a vehicular visual information (VI) processor 301 interfaces with a vehicle on-board system 302, a display 304, and one or more imagers (such as cameras, RADAR, LIDAR, FLIR, or other imager, for example) 306, which, as previously described, may be internal or external, and may be directed toward the interior of the vehicle cab or in the direction of vehicle travel to capture images in those respective directions, for example. Vehicular VI processor 301 and vehicle on-board systems 302 may include respective storage subsystems 308, 310. Storage subsystems 308, 310 may include: volatile or non-volatile memory technologies, electronic memory, and optical or magnetic disk technologies, as examples.

In exemplary embodiments in accordance with principles of inventive concepts, VI processor 301 may be a processor embedded within a cellular telephone, within a tablet or phablet computer, within a vehicular visual information component (e.g., a portable “box”), or other such electronic system. The VI processor 301 may be physically located within any component of a system in accordance with principles of inventive concepts (that is, within a display or within a camera, for example), it may be located within a system configured to operate as a VI system in accordance with principles of inventive concepts (that is, it may be the processor of a smartphone, phablet, or tablet, for example), or it may be in a separate housing produced specifically for the system or good be integrated with the electronics of the vehicle. Whatever option is chosen, the VI processor 301 will typically travel with the vehicle for which it provides images, image information, direction, and/or control. In exemplary embodiments in accordance with principles of inventive concepts, system 300 may be factory-installed or may be an aftermarket system installable by an end-user, for example.

In some embodiments a cellular telephone (or “cellphone” or “smartphone”), phablet, or tablet can include the display, VI processor, and camera. A VI application may be installed on the smartphone or tablet; stored, for example, in memory, and executable by the smartphone or tablet's processor to perform vehicular information system functions. A system in accordance with principles of inventive concepts may include a rotatable mount for a smartphone, which allows the smartphone camera to be positioned to capture images from any of a variety of angles inside or outside the vehicle to which it is mounted. Additionally, in accordance with principles of inventive concepts, an optical path modifier, such as an optical assembly which may include lenses and/or mirrors, may be included to allow a smartphone's camera to have light and images directed to it from a direction other than that in which its aperture is pointed. That is, for example, a smartphone may be positioned flat on the dash of a vehicle, with its aperture pointed in a vertical direction and an optical assembly may direct light, periscope-like, from the front of the vehicle, or from the interior of the vehicle, to the camera aperture.

In various embodiments, the system may also detect audio information, e.g., in combination with image information. In the case of a smartphone, phablet, or tablet, the microphone of the smartphone, phablet, or tablet could be used to detect and receive such audio. The audio could also be processed by the VI processor or a companion processor. If there is a companion processor, it can be included within the system.

Vehicle on-board systems 302 may include systems that enable vehicle control, such as a vehicle starter system for starting the vehicle engine, via a remote-starting interface, for example, data-logging systems, or operator assist systems, vehicle audio systems, and the like, for example.

Imager(s) 306 may include one or more of any of a variety of image capture systems or devices, which may be embodied as cellular telephone, pad computer, tablet computer, “lipstick,” stereo, or other camera type and may be fitted with any of a variety of lenses, such as telescopic, or wide-angle lens, for example. A plurality of such imagers may be positioned to provide enhanced views, including stereoscopic views, that may be used, for example, to provide three-dimensional image information (the machine-equivalent of depth perception, for example), which a system and method in accordance with principles of inventive concepts may employ in a variety of ways, such as in a proximity-warning application, for example.

Display 304 may be embodied as one or more non-obstructive or semi-obstructive displays, such as projection displays, for example. As previously described, such a display may project a semi-transparent collimated image onto a vehicle windshield, for example. In embodiments in which display 304 is not non-obstructive, it may employ the display of a cellular telephone, tablet computer, pad computer, navigation system (or other on-board display), as examples. In such embodiments the display may be positioned to minimize the obstruction of an operator's field of view while, at the same time, minimizing any head-movement or eye-movement required of the operator for viewing. As will be described in greater detail in the discussion related to the following figures, the display 304 may obtain display material directly from imager 306, from vehicular visual information processor 301, from vehicle on-board systems, from external or 3^{rd} party systems, or combinations thereof, for example. Operation of vehicular visual information processor 301 and its interaction with other system components will be described in greater detail in the discussion related to the following figures.

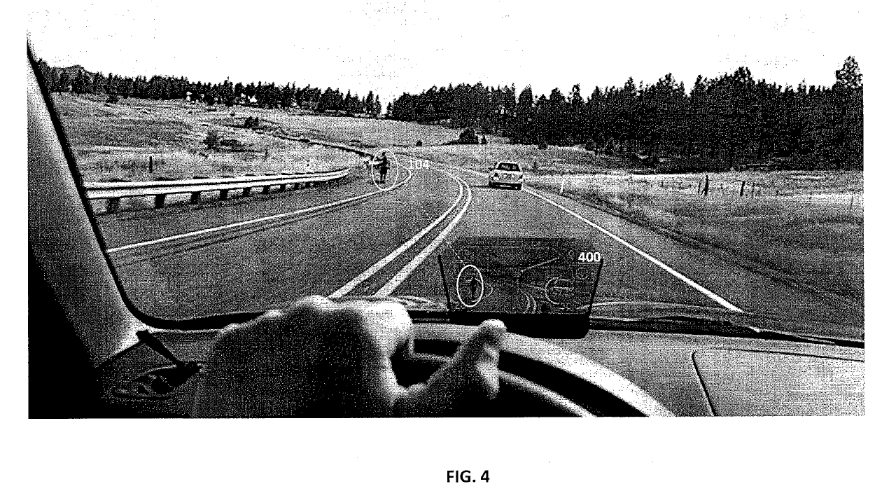

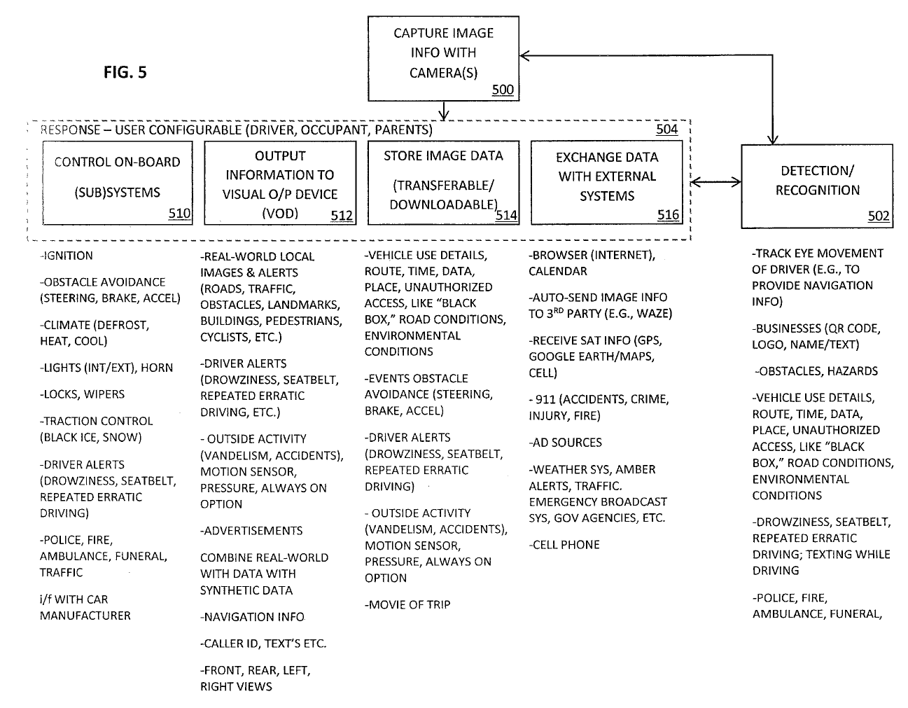

The forward-looking vehicular image of FIG. 4 illustrates an exemplary embodiment of a projection display 400 wherein the image is projected, not onto the vehicle windshield, but, rather, onto a dash-mounted semitransparent display. In other embodiments, display 400 need not be a projection display. In this exemplary embodiment, an image of the road ahead, obtained by one or more imagers in accordance with principles of inventive concepts, is projected onto display 400. Extra-image information, such as route and turning indicators are combined with the imager/camera-image information and projected onto display 400. In accordance with principles of inventive concepts, image-processing may be employed to recognize objects in an imager's field of view and to alert a vehicle operator. In this exemplary embodiment, a pedestrian 402 along the side of the road has been imaged, the image processed, and, through pattern recognition, for example, a system in accordance with principles of inventive concepts has provided the vehicle operator with an alert within display 400. The alert can take the form of a geometric shape, highlighting, flashing, or other graphical indicators presented in conjunction with the pedestrian 402. A system in accordance with principles of inventive concepts may also provide non-visual alerts, such as audio alerts, for example, particularly if a potential hazard, such as a pedestrian or bicycle rider, is within a threshold range of the vehicle, for example. For example, the threshold range could be determined based on distance to the obstacle (here pedestrian 402), which may considered speed of the vehicle, rate of convergence of vehicle and obstacle, as examples.

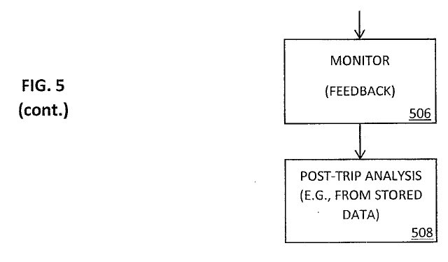

The flowchart of FIG. 5 illustrates an embodiment of a vehicular visual information method that may be employed by a vehicular visual information system in accordance with principles of inventive concepts. Although steps and processes preceding step 500 and following step 508 are contemplated within the scope of inventive concepts, the detailed discussion of processes and systems in accordance with principles of inventive concepts will be generally limited herein to those processes falling within the range of steps 500 to 508.

In step 500 image information is captured by one or more imagers in accordance with principles of inventive concepts, detection and/or recognition may be carried out in step 502, and a system response generated in step 504. Optionally, audio information may also be captured as part of step 504. In accordance with principles of inventive concepts, a system may monitor processes and provide feedback in step 506 and may provide output, such as post-trip analysis in step 508. Exemplary embodiments employing such steps will be described in greater detail below.

In this context, the term “image information” is meant to encompass optical light gathered by an imager lens, or lens system, and captured by an image sensor, and information determined or generated therefrom. The image sensor may be a complementary metal oxide semiconductor (CMOS), image sensor, a photodiode sensor, or a charge coupled device (CCD) sensor, as examples. The term “image information” may also be employed herein to encompass information extracted by vehicular visual information system processor 301, such as may be employed in pattern recognition, for example, including detected edges and multi-dimensional transforms, as will be described in greater detail below. That is, in addition to “raw” image information obtained directly through a lens, image information may include processed information that may be employed in the process of pattern recognition, for example. Such pattern recognition processes may be implemented using digital signal processing techniques and processors, may use neural-network classifiers, may employ fuzzy logic and may employ any one, or a combination, of hardware, firmware, and software in its implementation. In exemplary embodiments in accordance with principles of inventive concepts, image information may be pre-processed to varying degrees for recognition, enhancement, or other operations, by a focal plane array included within one or more imagers 306.

In accordance with principles of inventive concepts, a detection/recognition operation 502 may include tracking a vehicle operator's eye movement to enable a system in accordance with principles of inventive concepts to anticipate and/or implement commands from an operator or to determine if the operator has fallen asleep or is in distress. In that instance in which the detection/recognition operation 502 determines the exposed surface area of the operator's eyeball has diminished below a pre-determined amount (as evidenced, for example, by a lower reflectance level), the processor causes an audible warning to issue, for example, from a vehicle's horn, a cellular telephone, or other device associated with the vehicle, to awaken the operator. Such eye-tracking may be implemented in a manner similar to that of eye tracking systems employed in weapons-targeting systems, for example, with application, however, to navigation, or other vehicle-based system, such as, for example, in-car telephone, audio system, or climate control system. In another embodiment, the detection/recognition operation 502 determines the operator is present, but that operator's facial features or face has not been detected for a pre-determined amount of time and the processor causes an audible warning to issue, for example, from a vehicle's horn, a cellular telephone, or other device associated with the vehicle to awaken the operator.

A detection/recognition operation may also encompass the recognition and interpretation of iconography, such as business logos, business names, trademarks, text, bar code, quick response (QR) code, for example. Such recognition may be employed in a system in accordance with principles of inventive concepts in a number of ways, including, for example, to permit targeted advertising. With appropriate interpretation of iconography, a system in accordance with principles of inventive concepts may allow advertisers to provide geographically-coordinated advertising, with, for example, varying levels of a user's opting-in, as will be described in greater detail in the discussion related to response processes 504.

Pattern recognition may be employed to identify external obstacles and hazards, including those that are already marked (for example, recognizing a detour sign, a railroad crossing, or a flashing light) and those identified by the system itself (for example, a pedestrian walking on the roadside). The presence of emergency vehicles, such as police, fire, ambulance, funeral, wide-load, or slow-moving vehicles may be identified by the presence of flashing lights, for example. Additional hazards detected and/or recognized by a system in accordance with principles of inventive concepts may include wet road conditions, slick road conditions, the presence of ice, “black” or otherwise, on the roadway, and unusual traffic patterns that may indicate an accident ahead, for example.

Detection and recognition may be employed to identify navigation-related information, such as landmarks, and intersections where turns should be made. Erratic driving, which may be exemplified by repeatedly crossing over the center line of a road or by quick stops and starts (as determined, by imager 306, for example), may be detected.

With imagers directed at the interior of a vehicle, driver and passenger activities or patterns of movement may be detected, including, for example, driver head or eye motion that may indicate a lack of alertness or capacity due to sleepiness, to illness, such as diabetic shock, or to intoxication, as examples. The use (or lack thereof) of seat belts, non-driving behaviors, particularly those that a driver should not be engaged in while driving, such as texting, may be detected by a system in accordance with principles of inventive concepts.

Information detected in process 502 may be employed by response processes 504. In addition to image information detected in process 502, raw data (which may be preprocessed, for example, in a focal plane array or digital signal processor) may be obtained from the capture image process 500 and employed by response process 504. Response process 504 may include, but is not limited to, controlling on-board systems 510, sending information to a visual output device, such as vehicular visual information system 304, storing image information 514, and exchanging data with external systems 516, for example.

In accordance with principles of inventive concepts, a system and method may be provided that control vehicle on-board systems 510 by enabling or disabling engine ignition, for example. Such activity may be implemented through a custom interface or may employ an interface, such as is employed by a vehicle's remote start capability, for example. A detection/recognition process 502 may, for example, determine that the occupant of the vehicle's driver's seat is not authorized to drive the car, using facial, pupil, or other biologic identification process in conjunction with an inward-looking imager, for example to disable the vehicle ignition system, slow the vehicle, and/or generate an alert, for example.

The detection/recognition process 502 may also identify activities, such as texting, that may disable the vehicle ignition system, slow the vehicle, and/or generate an alert, for example. Once an obstacle is identified, as previously described, a system in accordance with principles of inventive concepts may employ the vehicle's steering, braking, or acceleration system to avoid such obstacles. Hazardous conditions, such as the detection of icy, snowy, or rainy surfaces, or other traction hazards may be accommodated by adjustment of an on-board traction control system, for example. Substantially autonomous control of a vehicle, including steering, starting, stopping, and accelerating, may be implemented using images captured by one or more imagers in a system in accordance with principles of inventive concepts.

In exemplary embodiments in accordance with principles of inventive concepts, a plurality of imagers may be employed to generate a three-dimensional model, or view, of the near-neighborhood of the vehicle. The system may compare the three-dimensional model of the vehicle's near-neighborhood to a detailed map in order to execute the appropriate control action (that is, start, stop, accelerate, decelerate, turn, etc.) to follow a particular course, which may have been developed using a navigational program or may have been entered by a user, for example. Autonomous vehicle control is known and disclosed, for example, in: U.S. Pat. No. 5,101,351 to Hattori, U.S. Pat. No. 5,615,116 to Gudat, U.S. Pat. No. 6,151,539 to Bergholz, U.S. Pat. No. 8,078,349 to Gomez, and U.S. Pat. No. 8,139,109 to Schmiedel, the contents of all of which are hereby incorporated by reference in their entirety. In accordance with principles of inventive concepts, such avoidance/autonomous operation measures may be overridden by an authorized driver, for example, the way cruise control can be overridden. Audio feedback, using a vehicle's built-in audio system, an audio system incorporated within a smartphone, phablet, tablet, or other electronic device, or a proprietary audio system, may be provided to a user, in response to determinations made by the system. For example, after plotting a course and commencing navigation of the course, a system in accordance with principles of inventive concepts may announce, audibly, the vehicle's progress along the route.

Exemplary embodiments of a system in accordance with principles of inventive concepts may produce a signal that indicates the location of the vehicle for use, not only for a vehicle operator, but for others. Such a locating signal, or “homing” signal, may be used for vehicle recovery, for use by traffic systems (to determine traffic-congestion levels, for example), or, for a vehicle operator, to display the location of the vehicle in traffic, for example. In accordance with principles of inventive concepts, a homing signal may be developed from a variety of sources, including satellite navigation sources, such as global positioning system (GPS), from dead-reckoning (updating the vehicle's location by adding distance and direction traveled to a known vehicle location), cellular tower triangulation, or a combination of any of the above methods, for example.

Location methods may be used to complement one another, for example, with a cellular tower triangulation method used when a satellite method is unavailable. Additionally, communication of the vehicle location may be through any of a variety of channels, including cellular telephone, satellite, or other communications systems.

In accordance with principles of inventive concepts, vehicle imagers may gather images and use those images to update and/or supplement a displayed image. Such updates/supplements may be used to provide an enhanced view of the vehicle's surroundings for an operator. For example, under poor-visibility conditions, an image of a given location taken at a time of better visibility may be overlain, with adjustable transparency level, on a “live” image of the location, thereby enhancing the operator's view of the area.

In accordance with principles of inventive concepts, the vehicle can serve as an image collection device that repeatedly collects and stores such image information, locally (at the vehicle), externally (system or network outside the vehicle) or a combination thereof. This can be the case for a plurality of vehicles that collectively contribute image information to a central or distributed database system for shared use across vehicles. The contributions can be made in real-time, near real-time, or post-capture, e.g., periodically, according to a schedule, when in a wi-fi network etc. Shared image information can be used, for example, to alert drivers to hazard or other road conditions, traffic, detours, roadblocks, emergencies, or other circumstances effecting traffic. For example, images from a first driver that were encountered by a vehicle traveling down a street can be instantly shared with another vehicle heading in the same direction or that uses the same route—or can be used to generate an alert to the second vehicle.

Collected image information could also be used by the VI processor (or other processor, e.g., external processor) in conjunction with the detection/recognition process 502 and/or the response processes 504 to determine and store a vehicle's or driver's normal routes and then advise a driver (e.g., through images, alerts, warnings, alternative route recommendations, or traffic updates) of abnormal conditions or circumstances existing along such routes. The system can also associate such routes with day and times of use, to predict when the vehicle would use the normal routes. These alerts etc. can be provided when the processor determines or estimates that the vehicle is traveling along one of the normal routes, or will be traveling along such route based on past travel history. In some embodiments, the driver could also be provided with information of a commercial nature relating to businesses along a route, e.g., sales or other promotional events. For example, prior to the vehicle passing a coffee shop on its route, the vehicle could receive an advertisement or coupon (or other promotional item or message) for that coffee shop.

Accordingly, vehicle-based imagers in a system in accordance with principles of inventive concepts may gather information related to surrounding traffic, store, and/or transfer that traffic information. Such information may be used by a system in accordance with principles of inventive concepts to alert others to traffic conditions, for example. By storing such information a system in accordance with principles of inventive concepts may track traffic patterns and trends and suggest alternate routes to a vehicle operator, for example. Sensors located in a vehicle, in one or more tires, for example, may detect vehicle speed and location and may be used to determine vehicle location (by dead reckoning, for example). Other manners of determining vehicle speed and location may be used. Location and speed information derived in any or a variety of fashions, such as those that leverage the image information, may be used to supplement satellite navigation location information or, if satellite location information is unavailable, to substitute for satellite navigation information.

Climate controls, including heating and air conditioning units, may be activated or adjusted, for example, to defrost front or rear windshields in response to conditions detected in process 502. A system may automatically turn on and adjust the speed and intermittency of wiper blades in response to windshield conditions that may result from any of a variety of weather conditions, for example, as determined using image information from the imager(s). Interior and exterior lights may automatically be adjusted to improve the visibility of both the road ahead and the vehicle's control panel. Such adjustments may take into account both interior and exterior lighting conditions and may employ a variety of the image and pattern recognition and detection techniques previously described, including, for example, tracking eye movement to determine whether to adjust the light levels of controls a user is directing his attention toward.

When driver activities that give rise to concern are detected (for example, nodding head, drifting or closing eyes, erratic driving), as previously described, a system in accordance with principles of inventive concepts may alert the driver using any of the vehicle's on-board systems, including lights, audio tones or patterns, horns, etc., in addition to alerts presented to a display (as will be described in greater detail in the discussion related to process 512). Alerts may also be generated in response to the detection of emergency vehicles, for example.

In accordance with principles of inventive concepts, a system may output to a display 304 information obtained from an imager 306 and/or a detection process 502, for example. Such information may include real time video imagery or images of the road ahead obtained from imager 306 combined with information from a navigation system, for example, which will be described in greater detail in the discussion related to the response process of exchanging data with external systems 516. Although the term external system is used, navigational information may, in fact, be integral to a system in accordance with principles of inventive concepts.

As indicated in the listing below process box 512, a system in accordance with principles of inventive concepts may supply to a display 304 “real world” imagery or images, such as real-time imagery or images provided by imager 306, for example, along with alerts or other indicators produced by detection recognition process 502. Indicators, such as arrow icons used to indicate to a driver where to turn, may also be displayed according to a navigational system. In accordance with principles of inventive concepts, a system may navigate according to input from an imager, matching, for example, street imagery or images obtained from a mapping service to real-time imagery or images from a imager in order to determine the appropriate locations for route modifications required to reach a destination. All the imagery or images required for a complete route determination and verification may be downloaded from a mapping service, for example. And, as the vehicle travels along a charted route, the detection/recognition process 502 may compare live imagery or images obtained along the route to route imagery or images downloaded from the mapping service and to thereby determine the appropriate places to alert an operator to turn (through an indicator displayed on display 304, for example). A subset of map imagery or images, for example, a set of images corresponding to turning locations, may be downloaded and compared to live images in order to provide navigational indicators to a user in accordance with principles of inventive processes.

Alerts may be presented on the display 304, as previously described, when a detection recognition process 502 determines that the driver is operating in a manner that could be interpreted as being unsafe (for example, with seatbelt unfastened, with eyes drooping or shut, with head wobbling, etc.).

Outside activities of interest, such as acts of vandalism, car-door to car-door impacts in a parking lot, accidents, various views (front, right, left, and rear) may be recorded and/or displayed. Caller identification and texts may also be displayed, in some embodiments.

Advertisements may be displayed, or otherwise (for example, through speech output) brought to the attention of a driver. Such advertisements may be in response to recognition of an icon, trademark, bar code, QR code, or other indication, for example, such as may be detected and recognized in process 502. A user may opt-in to advertisements at various levels. For example, a user may accept advertisements from any advertiser participating in an in-vehicle advertisement campaign. Or, a user may indicate his preferences, or his activities may be analyzed by a system in accordance with principles of inventive concepts to determine his preferences, for advertisements, for example the user may be particularly interested in certain coffee shops, restaurants, hardware stores, medical or legal offices, etc., and a system in accordance with principles of inventive concepts may supply the user with advertisements when the system determines that the user is proximate such an outlet.

In an image storage process 514 in accordance with principles of inventive concepts, various image information, imagery or images, whether forward-looking, internal-looking, or otherwise, may be recorded and stored locally or uploaded for remote storage, for example. Such stored image information, imagery or images may be employed for evidentiary purposes, should accidents, vandalism, or theft occur, for example, or may be employed by a user to chronicle a trip. In some embodiments, the stored image information, imagery or images can be uploaded to a system and shared with other vehicles, drivers, and/or systems. A system in accordance with principles of inventive concepts may employ a “sleep mode” for example, whereby it does nothing more than monitor motion sensors or otherwise awaits triggering events to begin recording imagery or images information. Imagery or images, or portions thereof, may be tagged with various types of data, such as time, location, route, speed, and environmental conditions, for example, as it is stored. Such information may be used in reconstructing a trip, or for other applications, for example.

A system and method in accordance with principles of inventive concepts may include a process 516 whereby the system exchanges data, particularly image data, with external systems. Such exchanges may include Internet browser activities, calendar functions, the reception of navigational information, such as global positioning system (GPS) location information, mapping information, street view information, advertising sources, amber alert, traffic information, cellular telephone, emergency broadcast information, and other governmental information (from, the national weather service, for example). The system may, as previously described, upload image information, particularly in the event of vandalism, accident, or theft, for example, and may automatically upload traffic alert information for a crowd-sourced traffic updates whenever the imager 306 detects an emergency and, if the type of emergency is identified in a detection/recognition process 502, that information (that is, the type of emergency) may also be uploaded. The uploads could require operator confirmation before being initiated, in some embodiments.

In process 506 a system in accordance with principles of inventive concepts may continue to monitor, via imager 306, for example, and adjust alerts and controls accordingly. That is, for example, if an inward-looking imager determines that a user is not using a seat belt, the system may continue to monitor the user and, optionally, prevent the vehicle from starting until the user is buckled in, or, in a less stringent approach, eventually allow the vehicle to be started and/terminate any alerts associated with the unbuckled seatbelt.

In a post trip analysis process 508 a system in accordance with principles of inventive concepts may provide a user with vehicle-performance related information and analyses (for example, miles per gallon, a better location for refueling for future trips, etc.) and user-performance related information and analyses (for example, the user appeared to doze at one point during a trip, the user was not paying attention when a hazard was detected, etc.).

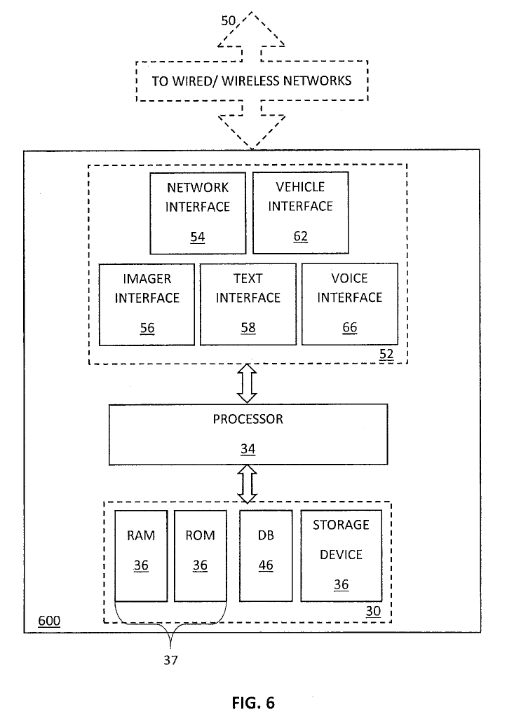

FIG. 6 is an exemplary block diagram of a computer architecture or system that may be employed as a vehicular visual information processor 301 in accordance with principles of inventive concepts. The VI processor 301 includes at least one processor 34 (e.g., a central processing unit (CPU)) that stores and retrieves data from an electronic information (e.g., data) storage system 30. As will be appreciated by those skilled in the art, while computer system 301 is shown with a specific set of components, various embodiments may not require all of these components and could include more than one of the components that are included, e.g., multiple processors. It is understood that the type, number and connections among and between the listed components are exemplary only and not intended to be limiting.

In the illustrative embodiment, processor 34 is referred to as CPU 34, which may include any of a variety of types of processors known in the art (or developed hereafter), such as a general purpose microprocessor, a digital signal processor or a microcontroller, or a combination thereof. CPU 34 may be operably coupled to storage systems 30 and configured to execute sequences of computer program instructions to perform various processes and functions associated with a vehicular visual information system, including the storing, processing, formatting, manipulation and analysis of data associated with the vehicular visual information and images. Computer program instructions may be loaded into any one or more of the storage media depicted in storage system 30.

Storage system 30 may include any of a variety of semiconductor memories 37, such as, for example, random-access memory (RAM) 36, read-only memory (ROM) 38, a flash memory (not shown), or a memory card (not shown). The storage system 30 may also include at least one database 46, at least one storage device or system 48, or a combination thereof. Storage device 48 may include any type of mass storage media configured to store information and instructions that processor 34 may need to perform processes and functions associated with the ad campaign management system. As examples, data storage device 48 may include a disk storage system or a tape storage system. A disk storage system may include an optical or magnetic storage media, including, but not limited to a floppy drive, a zip drive, a hard drive, a “thumb” drive, a read/write CD ROM or other type of storage system or device. A tape storage system may include a magnetic, a physical, or other type of tape system. An imager interface 31 provides for a link between processor 34 and imager 306.

While the embodiment of FIG. 6 shows the various storage devices collocated, they need not be, as they could be remote to each other, to processor 34 or both. Storage system 30 may be maintained by a third party, may include any type of commercial or customized database 46, and may include one or more tools for analyzing data or other information contained therein. As an example, database 46 may include any hardware, software, or firmware, or any combination thereof, configured to store data.

VI processor 301 may include a network interface system or subsystem 54 configured to enable initiation and interactions with one or more network 50 (a “cloud” for example). As such, computer system 301 may be configured to transmit or receive, or both, one or more signals related to a vehicular visual information system. A signal may include any generated and transmitted communication, such as, for example, a digital signal or an analog signal. As examples, network 50 may be a local area network (LAN), wide area network (WAN), virtual private network (VPN), the World Wide Web, the Internet, voice over IP (VOIP) network, a telephone or cellular telephone network or any combination thereof. The communication of signals across network 50 may include any wired or wireless transmission paths.

While inventive concepts have been particularly shown and described with references to exemplary embodiments thereof, it will be understood by those skilled in the art that various changes in form and details may be made therein without departing from the scope of inventive concepts encompassed by the appended claims.

1. An apparatus, comprising:
at least one vehicle-mounted camera configured to capture images;
a vehicle-mounted display; and
a visual information processor configured to combine images from the vehicle-mounted camera with extra-image information to generate an output to the display.

2. The apparatus of claim 1, wherein the processor is configured to provide navigational information based upon images captured by the at least one camera.

3. The apparatus of claim 1, wherein the display is a projection display.

4. The apparatus of claim 1, wherein the processor is configured to respond to images captured by the at least one camera by controlling operation of the vehicle.

5. (canceled)

6. The apparatus of claim 1, wherein the processor is configured to control operation of the vehicle in response to recognition of a visual biological characteristic of a potential operator.

7.-10. (canceled)

11. The apparatus of claim 1, wherein the processor is embedded within a cellular telephone and the display is a cellular telephone display.

12. The apparatus of claim 1, wherein the processor is configured to recognize alarm-triggering events captured by the at least one camera and to provide an alarm in response to such an event.

13.-15. (canceled)

16. The apparatus of claim 1, wherein the processor is configured to recognize a reportable event from images obtained by the at least one camera and to report the event to another system.

17. (canceled)

18. The apparatus of claim 3, wherein the projection display is configured to collimate the combined images and to project a semi-transparent image onto the front windshield of the vehicle.

19. The apparatus of claim 1, wherein the processor is configured to supply advertising information relevant to a vehicle location.

20.-21. (canceled)

22. A method, comprising:
at least one camera mounted to or within a vehicle capturing images;
a visual information processor combining images from the at least one vehicle-mounted camera with extra-image information and outputting the combined images to the display; and
a vehicle-mounted display displaying the combined images.

23. The method of claim 22, including the processor providing navigational information based upon images captured by the at least one camera.

24. (canceled)

25. The method of claim 22, including the processor responding to images captured by the at least one camera by controlling operation of the vehicle.

26. The method of claim 22, including the processor controlling operation of the vehicle by enabling starting of the vehicle.

27. The method of claim 22, or any other claim, including the processor controlling operation of the vehicle in response to recognition of a visual biological characteristic of a potential operator.

28.-31. (canceled)

32. The method of claim 22, wherein a cellular telephone provides the display.

33. The method of claim 22, including the processor recognizing alarm-triggering events captured by the at least one camera and providing an alarm in response to such an event.

34.-37. (canceled)

38. The method of claim 22, including:
the processor reporting a road hazard to a crowd-sourced road hazard awareness system.

39. The method of claim 22, including:
projecting the combined images, including collimating the combined images and projecting the collimated combined images as a semi-transparent image onto the front windshield of the vehicle.

40. The method of claim 22, including the processor supplying advertising information relevant to a vehicle location.

41.-66. (canceled)
